(19) United States
(12) Patent Application Publication
(10) Pub. No.: US 2013/0198453 A1
(43) Pub. Date: Aug. 1, 2013

(54) HYBRID STORAGE DEVICE INCLUCING NON-VOLATILE MEMORY CACHE HAVING RING STRUCTURE

(71) Applicant: KOREA ELECTRONICS TECHNOLOGY INST, Seonganam-si (KR)

(72) Inventors: Young Hwan KIM, Yongin-si (KR); Jae Gi SON, Yongin-si (KR); Chang Won PARK, Hwaseong-si (KR)

(73) Assignee: KOREA ELECTRONICS TECHNOLOGY INSTITUTE, Seonganam-si (KR)

(21) Appl. No.: 13/623,414

(22) Filed: Sep. 20, 2012

(30) Foreign Application Priority Data
Jan. 26, 2012 (KR) 10-2012-0007544
Jan. 26, 2012 (KR) 10-2012-0007545
Jan. 26, 2012 (KR) 10-2012-0007546

(51) Int. Cl. G06F 12/08

(52) U.S. Cl. 711/118; 711/E12.017

(57) ABSTRACT

A storage device is provided. The storage device has a storage region configured in a ring structure, and is divided into a reading cache region and writing cache region, thereby reducing electricity consumption and increasing speed of the storage device.

### BACKGROUND OF THE INVENTION

1. Field of the Invention

Methods and apparatuses consistent with the exemplary embodiments relate to a storage device, and more particularly, to a hybrid storage device including non-volatile memory cache having ring structure.

2. Background Art

As green IT is increasing attention due to recent environmental problems, various researches are underway on efficient energy management of storage systems having high power consumption rates. As the development of the internet vitalizes network services such as web servers and E-commerce, there is a tendency of using high-performance high-capacity disks to store large volumes of data, and using disks instead of tapes for data backup. Disks may be classified into active modes which perform I/O operations, Idle Modes which wait for IO requests, and Standby Modes which stop rotating disks when there is no IO request for a certain period of time. Power consumed during an Idle Mode is saved only by 20% of the power consumed during an Active Mode. As a result, a disk consumes a large volume of power even when it is not performing an IO operation unless it enters into an Idle Mode.

Flash memories are used as alternatives to disks in order to significantly reduce power consumption. A flash memory has a shorter delay time and uses less power. However, a flash memory is far more expensive per unit of capacity compared to a disk, and thus is not appropriate for a storage system operated as a high-capacity disk. However, it is possible use a cache instead of a flash memory, and send frequently reused data to the cache and have the disk maintain a waiting mode, thereby saving energy and improve performance. The delay time may deteriorate compared to when expanding and using a DRAM cache, but this is less expensive than a DRAM and has a good random access reading performance. Thus, this method may be a good alternative as a disk cache.

As such, methods of using a flash memory cache to improve disk performance and save energy have been studied from the past. But, the studies only offered basic system structures and algorithms, and took no consideration of data allocation, wear-leveling etc. according to flash memory characteristics.

As such, there is a need to seek ways to provide a flash memory management method which takes into account characteristics of a flash memory, in using it as a cache.

### SUMMARY OF THE INVENTION

1. Technical Problem

An aspect of the exemplary embodiments relates to a storage device having a storage region configured in a ring structure, and a reading cache region and writing cache region provided separately.

Another aspect of the exemplary embodiments relates to a data processing method which, when a reading access is requested, performs a reading access in block units in a reading cache region of a non-volatile memory cache, and when a writing access is requested, performs a writing access in block units in a writing cache region of a non-volatile memory cache.

Another aspect of the exemplary embodiments relates to a data processing method which, when there is a reading access request for new data corresponding to K number of blocks (K=natural number of 1 or above) in a state where one empty block is left in a reading cache region of a non-volatile memory cache, performs a replacing operation, and when all pages of a writing cache region of a non-volatile memory cache are used, performing a garbage collection operation.

2. Solution to Problem

A storage device, according to an exemplary embodiment of the present disclosure for achieving the aforementioned purpose, may include a non-volatile memory cache which is embodied as a non-volatile memory and performs a cache function of storing data temporarily; and a CPU which accesses data from the non-volatile memory cache, wherein the non-volatile memory cache has a storage region configured in a ring structure.

In addition, the non-volatile memory cache may be divided into a reading cache region and writing cache region.

Furthermore, the reading cache region may have more storage regions allocated than the writing cache region.

In addition, the non-volatile memory cache may include a writing cache region used for writing access operations; a reading cache region used for reading access operations; and a first reservation region and second reservation region which are regions reserved for an outplace update and garbage collection.

In addition, the first reservation region may be allocated to have a size same as or within twice the size of the writing cache region, and the second reservation region may be allocated to have a size same as or within twice the size of the writing cache region.

Furthermore, the non-volatile memory cache may be one of an SSD (Solid State Drive) and flash memory.

Meanwhile, a data processing method according to another exemplary embodiment of the present disclosure may include, when a reading access is requested, executing a reading access in block units in a reading cache region of a non-volatile memory cache having a storage region configured in a ring structure; and when a writing access is requested, executing a writing access in page units in a writing cache region of the non-volatile memory cache.

In addition, the executing a reading access may include, when a reading access is requested, searching in block units whether or not first data which corresponds to the requested reading access exists in a reading cache region of a non-volatile memory cache; when first data exists in a reading cache region, reading corresponding data from a first block which is a block corresponding to the first data; displaying that there has been an access to a spare region of the first block; and corresponding a reading allocation pointer to an empty block located next to the first block.

Furthermore, the executing a reading access may include, when a reading access is requested, searching in block units whether or not first data which corresponds to the requested reading access exists in a reading cache region of a non-volatile memory cache; when the first data does not exist in a reading cache region, reading first data from a disk array; recording first data in a second block which is an empty block where a reading allocation pointer corresponds to; displaying that data has been recorded in a spare area of the second block but there has been no access; and corresponding a reading allocation pointer to an empty block located next to the second block.

In addition, the executing a writing access may include, when a writing access is requested, searching in page units whether or not second data which corresponds to the requested writing access exists in a writing cache region of the non-volatile memory cache.

Furthermore, the executing a writing access may further include, when the second data exists in a writing cache region, displaying that data recorded in a spare area of page 1 which is a page corresponding to second data has been invalidated; displaying that there is an invalidated page in a spare region of a third block which is a block including the page 1; and recording second data in a first reservation region of the non-volatile memory cache; and corresponding a writing allocation pointer to an empty page located next to the first page.

In addition, the executing a writing access may further include, when the second data does not exist in a writing cache region, recording the second data in page 2 which is an empty page where a writing allocation pointer corresponds to; displaying that data recorded in a spare region of the page 2 is valid; when there is an empty page in a block which includes the page 2, shifting the writing allocation pointer (W_alloc_ptr) to a next empty page; and when there isn't an empty page in a block which includes the page 2, shifting the writing allocation pointer to a next block.

Meanwhile, a data processing method according to another exemplary embodiment of the present disclosure, may include, when there is a reading access request for new data corresponding to K number of blocks (K=natural number which is or above 1) in a state where one empty block is left in a reading cache region of a non-volatile memory cache having a storage region configured in a ring structure, selecting K number of blocks of among blocks of the reading cache region and performing a replacing operation of recording the new data; and when all pages of a writing cache region of the non-volatile memory cache has been used, performing a garbage collection operation of recording valid data recorded in a writing cache region in a disk array, and deleting the writing cache region and then shifting as many as a certain number of blocks.

Furthermore, the performing a replacing operation may include, when there is a reading access request for new data corresponding to K number of blocks in a state where one empty block is left in the reading cache region, selecting K number of blocks to be replaced in the reading cache region; deleting the K number of blocks to be replaced and changing them into empty blocks; recording the new data in one existing empty block and in the selected K number of empty blocks; displaying a value indicating that there has been no access to a spare region of blocks where the new data is recorded; and corresponding a reading allocation pointer to one empty block left of among the selected K number of blocks.

Furthermore, the selecting may use a reading replacement pointer and bit value of a spare region of a block, to select the block to be replaced.

In addition, the selecting may use an access list to select the block to be replaced.

In addition, the performing a garbage collection operation may include, when all pages of the writing cache region are used, recording all valid pages existing in invalidated blocks of among blocks of the writing cache region in a block of a first reservation region; deleting all invalidated blocks in the writing cache region; copying data of valid blocks existing in the writing cache region and data recorded in a block of a first reservation region in the non-volatile memory cache, in a disk array of the storage device; deleting valid blocks in the writing cache region and at least one block where data of the first reservation region is recorded; and shifting the writing cache region as many as at least one number of blocks where data of the first reservation region is recorded.

In addition, the invalidated block may be a block which indicates that a spare region includes a page where data is invalidated, and the valid page may be a page which indicates that data in a spare region of the page is valid.

3. Advantageous Effects of Invention

According to various exemplary embodiments of the present disclosure, a storage region is configured in a ring structure and has a separately provided reading cache region and writing cache region, and thus consumes less power but has a high speed.

In addition, according to various exemplary embodiments of the present disclosure, a data processing method, when a reading access is requested, performs a reading access in block units in a reading cache region of a non-volatile cache, and when a writing access is requested, performs a writing access in block units in a cache region of a non-volatile memory cache, thereby enabling the storage device to consume even lesser power and to have a high processing speed.

In addition, according to various exemplary embodiments of the present disclosure, a data processing method performs a replacing operation when a reading access is requested for new data corresponding to K number of blocks (K=natural number of or above 1) in a state where one empty block is left in a reading cache region of a non-volatile memory cache, and performs a garbage collection operation when all pages of a writing cache region of a non-volatile memory cache are used, thereby enabling the storage device to consume even lesser power and to have a high processing speed.

### BRIEF DESCRIPTION OF THE DRAWINGS

The above and/or other aspects of the present disclosure will be more apparent by describing certain present disclosure with reference to the accompanying drawings, in which:

FIG. 1 is a view illustrating a configuration of a storage device using a non-volatile memory cache according to an exemplary embodiment of the present disclosure;

FIG. 2 is a view illustrating a configuration of a non-volatile memory cache having a ring structure according to an exemplary embodiment of the present disclosure;

FIG. 3A is a view illustrating a configuration of a block according to an exemplary embodiment of the present disclosure;

FIG. 3B is a view illustrating a block which includes a plurality of pages according to an exemplary embodiment of the present disclosure;

FIG. 4A is a view illustrating a state of a non-volatile memory cache having a ring structure before data is processed, according to an exemplary embodiment of the present disclosure;

FIG. 4B is a view illustrating a case where a data processing for reading and writing has been performed, according to an exemplary embodiment of the present disclosure;

FIG. 4C is a view illustrating a case where data of a second block is outplace updated, according to an exemplary embodiment of the present disclosure;

FIG. 5A is a view illustrating a case where an access has occurred for new data corresponding to three blocks when one empty block is left in a reading cache region, according to an exemplary embodiment of the present disclosure;

FIG. 5B is a view illustrating a state where three blocks are selected as empty blocks, according to an exemplary embodiment of the present disclosure;

FIG. 6A is a view illustrating a case where an access occurred for new data corresponding to three blocks in a state where one empty block is left of a reading cache region, according to an exemplary embodiment of the present disclosure;

FIG. 6B is a view illustrating a state where three blocks are selected as empty blocks using an access list, according to an exemplary embodiment of the present disclosure;

FIG. 7A is a view illustrating a case where all writing cache regions are used, according to an exemplary embodiment of the present disclosure; and

FIG. 7B is a view illustrating a state where a writing cache region has been shifted by one block in a clockwise direction in a garbage collection process, according to an exemplary embodiment of the present disclosure.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

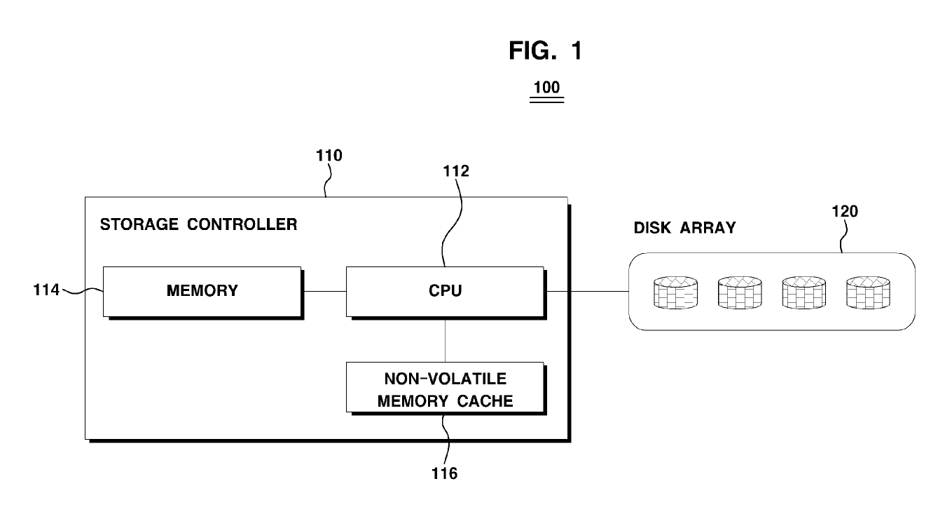

FIG. 1 is a view illustrating a configuration of a storage device 100 which uses a non-volatile memory cache, according to an exemplary embodiment of the present disclosure. As illustrated in FIG. 1, the storage device 100 includes a storage controller 110 and disk array 120.

As illustrated in FIG. 1, the storage controller 110 includes a CPU 112, memory 114, and non-volatile memory cache 116. The CPU 112 controls overall operations of the storage device 110. The memory 114 is a space for temporarily storing data which the CPU processes, and a RAM and cache memory etc. are included.

The non-volatile memory cache 116 is a large capacity cache using a non-volatile memory such as an SSD etc. The non-volatile memory used in the non-volatile memory cache 116 may be an SSD where a flash memory is used. It may also use an SSD (Solid State Drive) which uses various types of non-volatile memories besides the above. For example, any non-volatile memory cache such as an SSD and flash memory etc. may be applied to the non-volatile memory cache 116 as long as it is a non-volatile memory cache.

The disk array 120 includes a plurality of disks to embody a large capacity storage space.

When a data approach request is made, the CPU 112 first searches whether or not there is data in the memory 114. In addition, if there is data in the memory, the CPU 112 access corresponding data. On the other hand, if there is no data in the memory 114, the CPU 112 searches whether or not corresponding data is in the non-volatile memory cache 116. Furthermore, if there is data in the non-volatile memory cache 116, the CPU 112 accesses corresponding data. On the other hand, if there is no data in the non-volatile memory cache 116, the CPU 112 access corresponding data in the disk array 120.

As such, the CPU 112 tries to access data in an order of memory 114 -> non-volatile memory cache 116 -> disk array 120. Accordingly, the storage device 100 may improve disk 10 performance and reduce power consumption by using the non-volatile memory cache 116.

Meanwhile, any electronic device which includes a non-volatile memory cache 116 may be applied as the storage device 100 in FIG. 1. For example, the storage device 100 may be one of a computer device, disk array device, server device, notebook computer, and mobile phone etc. as long as it includes a non-volatile memory cache 116.

Hereinafter is a detailed explanation of a configuration and operations of a non-volatile memory cache 116. The configuration and operations of a non-volatile memory cache 116 explained below may be performed by the CPU 112 according to algorithms explained hereinbelow.

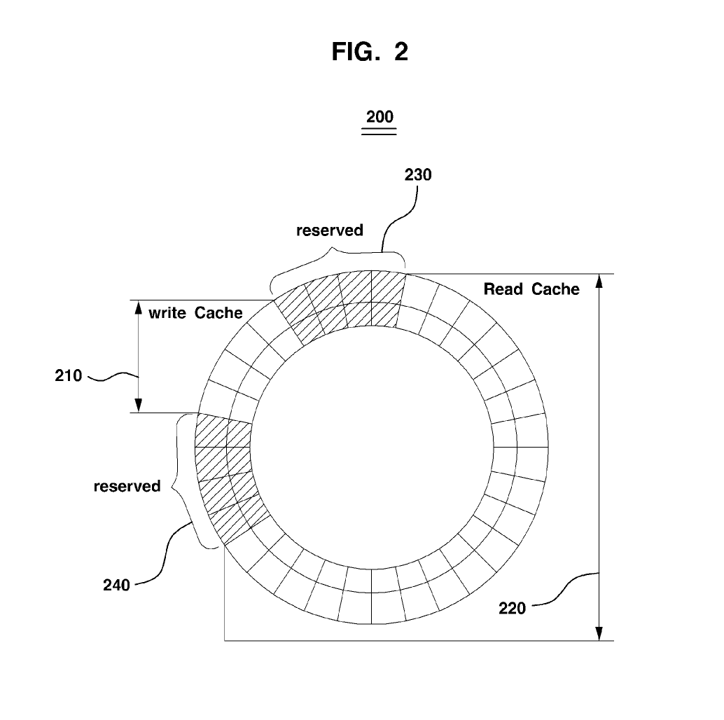

FIG. 2 is a view illustrating a configuration of a non-volatile memory cache 200 having a ring structure. Herein, the non-volatile memory cache 200 is a non-volatile memory cache 160 of FIG. 1, which may be an SSD cache or flash memory cache etc.

As illustrated in FIG. 2, the non-volatile memory cache 200 has storage regions configured in a ring structure. In practice, the non-volatile memory cache 200 has a ring structure as a last data block is connected to a first block.

As illustrated in FIG. 2, the non-volatile memory cache 200 includes a writing cache region 210, reading cache region 220, first reservation region 230, and second reservation region 240.

The writing cache region 210 is a region used for proceeding with a writing access operation, whereas the reading cache region 220 is a region used for proceeding with a reading access operation. As such, the non-volatile memory cache 200 has separately provided reading region and writing region, thereby reducing a cache missing rate.

In addition, as illustrated in FIG. 2, the reading cache region 220 has more storage regions allocated than the writing cache region 210. The reading cache region 220 has a high hit rate, is not sensitive to an out-place update, and has more reading access than writing access, and thus may maximize IO efficiency by allocating many reading cache regions 220.

More specifically, the reading cache region 220, writing cache region 210, the first reservation region 230, and second reservation region 240 may take up 70%, 10%, 10%, 10%, respectively, of an entire cache space.

In addition, the first reservation region 230 and second reservation region 240 are regions reserved for an out-place update and garbage collection.

The out-place update is a method of updating data based on electrical characteristics of a flash memory which is a non-volatile memory. Due to the electrical characteristics of the flash memory, it is impossible to in-place update data on an already used page. Therefore, in order to correct data in the flash memory, an empty region has to be allocated to record new data, invalidating the previous data page in a spare region. And this method is called an out-place update. Herein, the region where new data is recorded for an out-place update becomes the first reservation region 230 and the second reservation region 240.

In addition, when most of the pages in the writing cache region 210 are used and thus there is insufficient empty region, a garbage collection becomes necessary. The garbage collection refers to deleting blocks where invalidated pages dispersed in a block inside the writing cache region 210 to secure an empty block region. The first reservation region 230 and second reservation region 240 are used in such a garbage collection. To this end, each of the first reservation region 230 and second reservation region 240 may be same as or twice the size of the writing cache region 210.

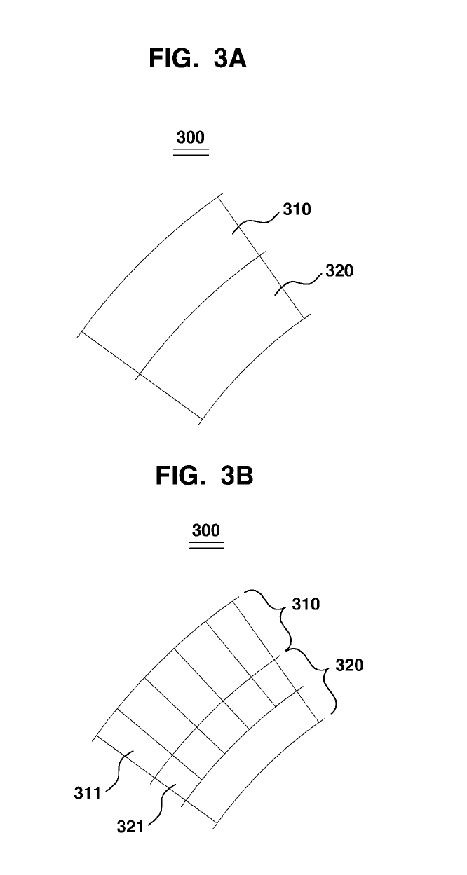

As illustrated in FIG. 2, the non-volatile memory cache 200 having a ring structure is divided in block units. Hereinbelow is a detailed explanation of a configuration of a block with reference to FIGS. 3A and 3B.

FIG. 3A is a view illustrating a configuration of a block 300 according to an exemplary embodiment of the present disclosure. As illustrated in FIG. 3A, a block 300 includes a data region 310 and spare region. The data region 310 is a region where actual data is recorded in page units. In addition, in the spare region 320, related meta data is recorded in corresponding block units or page units in the blocks. More specifically, in the spare region 320, whether or not data is recorded in the data region 310, whether or not there has been an access, and whether or not data recorded in the data region 310 is valid. For example, the spare region 320 of a block of the reading cache region 220 represents an empty block if there is no value, and if the value is “0”,it means that data is recorded in the data region 310, but there hasn't been any access, and when the value is “1”, it means that data is recorded in the data region 310, and that there has been an access.

Meanwhile, one block 300 includes a plurality of pages. FIG. 3B is a view illustrating a block 300 which includes a plurality of pages, according to an exemplary embodiment of the present disclosure. As illustrated in FIG. 3B, one block 300 includes a plurality of pages. One page includes a page data region 311 and page spare region 321. The page data region 311 actually becomes a unit region of data reading and writing. In addition, on the page spare region 321, information on a state of a corresponding page is recorded.

For example, a spare region 321 of a page of the writing cache region 210 indicates an empty page when there is no value, and when the value is “I”, it means that data is recorded in the page data region 311 but has been invalidated, and when the value is “V”, it means that data is recorded in the page data region 311 and the data is valid.

In addition, the spare region 320 of a block of the writing cache region 210 not having a value indicates an empty block where all pages are empty, if the value is “I”, it means that there is at least one page of among the plurality of pages in the corresponding block which has been invalidated, and if the value is “V”, it means that the plurality of pages in the corresponding block are all valid.

Hereinafter is an explanation of a data processing method for reading and writing data in the non-volatile memory cache 200 having a ring structure. The non-volatile memory cache 200 having a ring structure performs an access in page units in the writing cache region 210, and performs an access in block units in the reading cache region 220.

First of all, hereinbelow is an explanation on a method of reading data in the non-volatile memory cache 200 having ring structure.

In a case where a reading access is requested, the storage device 100 searches in block units whether or not first data which is data corresponding to the request reading access exists in the reading cache region 220 of the non-volatile memory cache 200.

If the first data exists in the reading cache region 220, the storage device 100 reads the corresponding data from a first block corresponding to the first data. In addition, the storage device 100 shows that there has been an access in the spare region of the first block. For example, the storage device 100 changes a bit which indicates whether or not there has been an access in the spare region of the first block from ‘0’ to ‘1’. Next, the storage device 100 corresponds a reading allocation pointer (R_alloc_ptr) to an empty block located next to the first block. Herein, the reading allocation pointer is a pointer used to find an empty block in the reading cache region 220.

On the other hand, if the first data does not exist in the reading cache region 220, the storage device 100 reads the first data from the disk array 120. In addition, the storage device 100 records the first data in the second block which is an empty block where the reading allocation pointer (R_alloc_ptr) corresponds to. Furthermore, the storage device 100 shows that data is recorded in the spare region of the second block but there has not been any access. For example, the storage device 100 displays a bit which indicates whether or not there has been an access in the spare region as ‘0’. Next, the storage device 100 corresponds the reading allocation pointer (R_alloc_ptr) to an empty block located next to the second block.

Through such a process, the storage device 100 becomes able to read data in the non-volatile memory cache 200 having a ring structure.

Secondly, hereinbelow is an explanation of a method of writing data in the non-volatile memory cache 200 having a ring structure.

In a case where a writing access is requested, the storage device 100 searches in page units whether or not second data which is data corresponding to the requested writing access exists in the writing cache region 210 of the non-volatile memory cache 200.

If the second data exists in the writing cache region 210, the storage device 100 displays that the data recorded in the spare region of page 1 which is the page corresponding to the second data has been invalidated. For example, the storage device 100 changes the bit which indicates a state of the spare region of page 1 from ‘V’ to ‘1’ (from valid to invalid). In addition, the storage device 100 displays that there is an invalidated page in the spare region of the third block which is the block where page 1 is included. For example, the storage device 100 changes the bit which indicates the state of the spare area of the third block from ‘V’(or ‘0’) to ‘1’ (or ‘1’)(from valid to invalid). Next, the storage device 100 records the second data in the first reservation region 230. Furthermore, the storage device 100 corresponds the writing allocation pointer (W_alloc_ptr) to an empty page located next to page 1. Herein, the writing allocation pointer is a pointer used to find an empty page in the writing cache region 210. Such a process is a method of updating changed data, and is called out-place update.

On the other hand, if second data does not exist in the writing cache region 210, the storage device 100 records the second data in page 2 which is an empty page where the writing allocation pointer (W_alloc_ptr) corresponds to. In addition, the storage device 100 displays that the data recorded in the spare region of page 2 is valid. For example, the storage device 100 displays a bit which indicates the state of the spare region of page 2 as ‘V’ (or ‘0’) (valid). Furthermore, if there is an empty page in the block where page 2 is included, the storage device 100 shifts the writing allocation pointer (W_alloc_ptr) to a next empty page. On the other hand, if there isn't an empty page in the block where page 2 is included, the storage device 100 shifts the writing allocation pointer (W_alloc_ptr) to the next block.

Through such a process, the storage device 100 becomes able to write or update (out-place update) data in the non-volatile memory cache 200 having a ring structure.

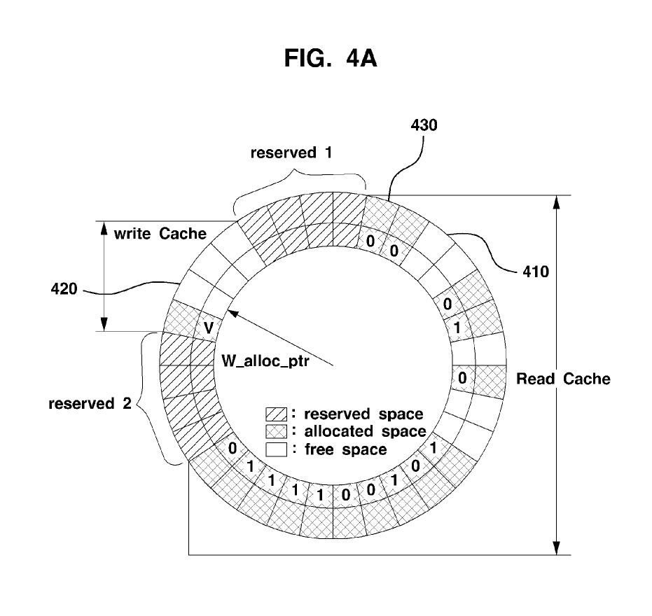

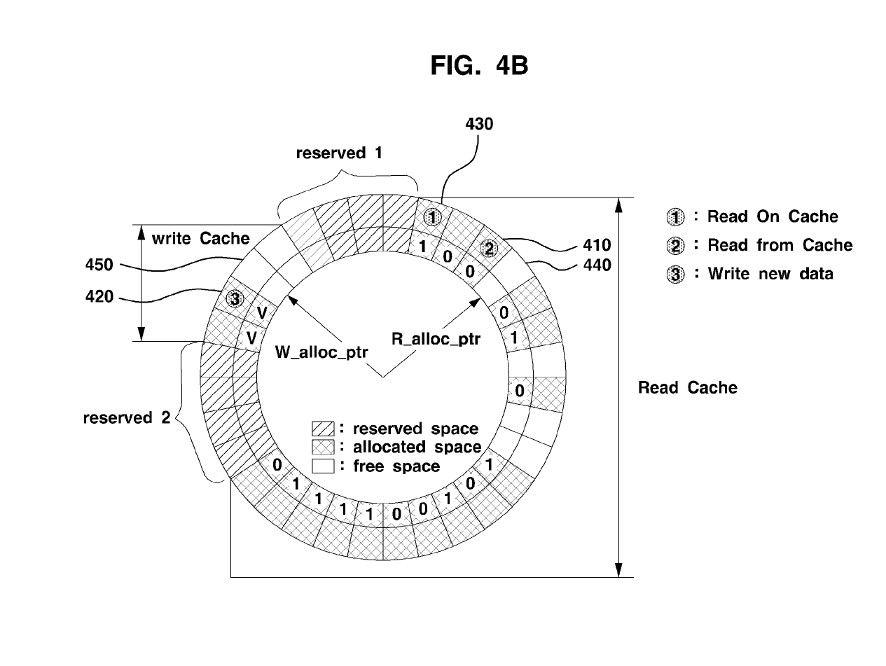

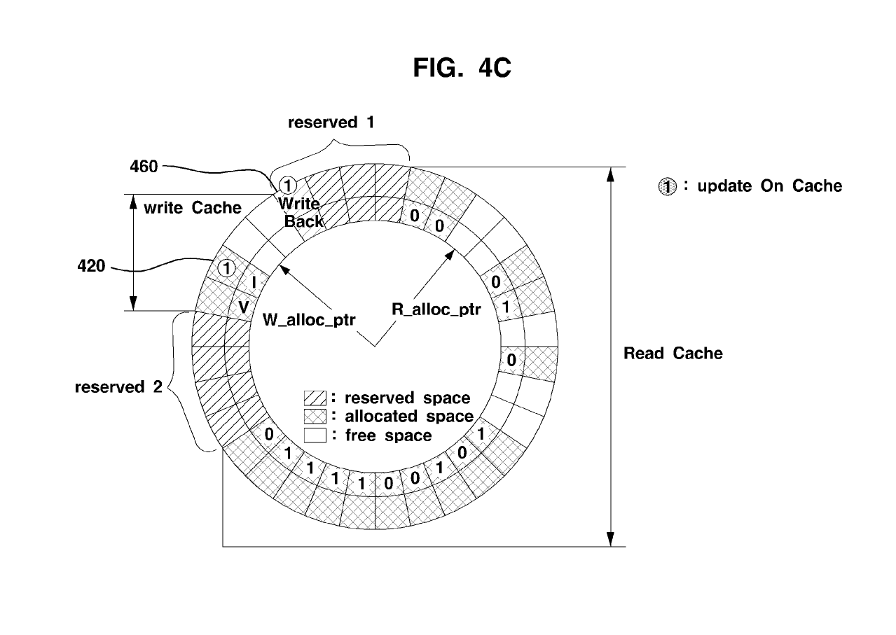

Hereinbelow is an explanation of a data processing method for reading and writing data in the non-volatile memory cache 200 having a ring structure, with reference to FIGS. 4A to 4C.

FIG. 4A is a view illustrating a state of the non-volatile memory cache 200 having a ring structure, before date is processed, according to an exemplary embodiment of the present disclosure.

As illustrated in FIG. 4A, in the reading cache region 220, empty blocks and blocks where data is recorded are included, wherein blocks where data is recorded display ‘0’ which indicates that there has been no access in the spare region and ‘1’ which indicates that there has been access for the data. In addition, it can be seen that the reading allocation pointer (R_alloc_ptr) corresponds to the first block 410 which is an empty block.

In addition, as illustrated in FIG. 4A, in the writing cache region 210, empty blocks and blocks where data is recorded are included. Furthermore, in a case where data is recorded in at least one page of among all the pages included and the recorded pages are all valid pages, the corresponding block displays ‘V’ which indicates that the data in the spare region is valid. In addition, the writing allocation pointer (W_alloc-ptr) corresponds to the second block 420 which is an empty block.

FIG. 4B is a view illustrating a case where data processing on reading and writing has been performed, according to an exemplary embodiment of the present disclosure. In FIG. 4B, \textcircled{1} indicates performing a reading access to data recorded in the third block 430 of the reading cache region 220, \textcircled{2} indicates recording data not recorded in the reading cache region 220 in the first block 410 and performing a reading access, and \textcircled{3} indicates recording data in the second block 420 and performing a writing access.

As can be seen from a comparison between FIG. 4A and FIG. 4B, it can be seen that the value of the spare region changed from ‘0’ to ‘1’ as the third block 430 performed \textcircled{1} process.

In addition, it can be seen data is recorded in the data region and ‘0’ is displayed on the spare region as the first block 410 performs \textcircled{2} process. It can be seen that the reading allocation pointer (R_alloc_ptr) changed its location from the first block 410 to its next block, that is, the fourth block 440.

In addition, it can be seen that data is recorded in the data region and ‘V’ is displayed on the spare region as the second block 420 performs\textcircled{3} process. In addition, since all pages were recorded in \textcircled{3} process, it can be seen that the writing allocation pointer (W_alloc_ptr) changed its location from the second block 420 to its next block, that is the fifth block 450.

Meanwhile, FIG. 4C is a view illustrating a case where data in the second block 420 is out-place updated, according to an exemplary embodiment of the present disclosure.

\textcircled{1} in FIG. 4C illustrates a case of performing an out-place update on data recorded in the second block 420 of the writing cache region 210. As illustrated in FIG. 4C, when data of pages corresponding to a portion or an entirety of the data recorded in the second block 420 is updated, the updated data is recorded in page units updated in the sixth block 460 of the first reservation region 230. In addition, a page to be updated of the second block 420 displays ‘I’ in the spare region so as to indicate that the data is invalid, and displays ‘I’ also in the spare region of the second block 420 so as to indicate that there is a page where data is invalid.

Through such a process, the storage device 100 becomes able to perform a reading and writing access for the data.

Hereinbelow is an explanation on the data processing method for replacing and for a garbage collection of data recorded in the non-volatile memory cache 200 having a ring structure. Herein, a replacing operation is an operation performed when there are insufficient empty blocks in the reading cache region 220, and a garbage collection operation is an operation performed when there is insufficient empty blocks in the writing cache region 210.

First is an explanation on the data processing method of replacing data recorded in the non-volatile memory cache 200 having a ring structure.

In a case where there is reading access request for new data corresponding to at least one block (hereinafter referred to as K: K is a natural number of or above 1) in a state where one empty block is left in the reading cache region 220 of the non-volatile memory cache 200 having a ring structure, the storage device 100 performs an operation of selecting K number of blocks of among the blocks of the reading cache region 220 and recording new data.

More specifically, in a case where there is a reading access request for new data corresponding to K number of blocks in a state where one empty block is left in the reading cache region 220, the storage device 100 selects K number of blocks to be replaced in the reading cache region 220. There are two ways to select blocks to be replaced, which will be explained hereinafter.

As a first method, the storage device 100 may use the reading replacement pointer (R_rep_ptr) and the bit value of the spare area of the block to select the blocks to be replaced. More specifically, the storage device 100 checks the value of the spare area of the block while consecutively shifting the reading replacement pointer (R_rep_ptr) from the one block left in a certain direction. If the spare region of the block corresponding to the reading replacement pointer has a value which indicates that there has been an access (for instance, ‘1’), the storage device 100 changes the value of the spare region of the corresponding block to a value which indicates that there has not been any access (for instance, ‘0’). Meanwhile, if the spare region of the block corresponding to the reading replacement pointer has a value which indicates that there has not been any access (for instance, ‘0’), the storage device 100 deletes the corresponding block and changes it to an empty block. The storage device 100 repeats this process until K number of empty blocks are obtained.

As a second method, the storage device 100 may apply a method of using an access list to select blocks to be replaced. Herein, the access list is a list which follows an LRU (Least Recently Used) algorithm and indicates an approximate access frequency of blocks. Herein, in the access list, items corresponding to all the blocks of the reading cache region 220 are arranged sequentially. In addition, in the access list, a front portion is called a Head, and a back portion is called a Tail, and closer to the Head, the blocks have more recent history of access, and closer to the Tail, the blocks have been accessed longer ago.

More specifically, the storage device 100 checks the value of the spare region of the block consecutively starting from the blocks in the Tail of the access list in a Head direction. If the spare region of the corresponding block has a value which indicates that there has been an access (for instance, ‘1’), the storage device 100 changes the value of the spare region of the corresponding block to a value which indicates that there has not been an access (for instance, ‘0’). On the other hand, if the spare region of the block where the reading replacement pointer corresponds to has a value which indicates that there has not been an access (for instance, ‘0’), the storage device 100 deletes the corresponding block and changes it into an empty block. The storage device 100 repeats this process until K number of empty blocks are obtained.

As such, the storage device 100 may select the blocks to be replaced in two methods.

Next, the storage device 100 records corresponding data in the one existing empty block and in newly obtained empty blocks K number of blocks, and displays the value (for instance, ‘0’) which indicates that there has not been any access in the spare region of the blocks where data is recorded. Furthermore, the storage device 100 corresponds the reading allocation pointer (R_alloc_ptr) to the one empty block left.

Herein, in a case of selecting blocks to be replaced in the second method, the storage device 100 shifts the items corresponding to the blocks where data is recorded towards the Head in the access list.

Through such a process, the storage device 100 becomes able to perform the data processing method of replacing data recorded in the non-volatile memory cache 200 having a ring structure.

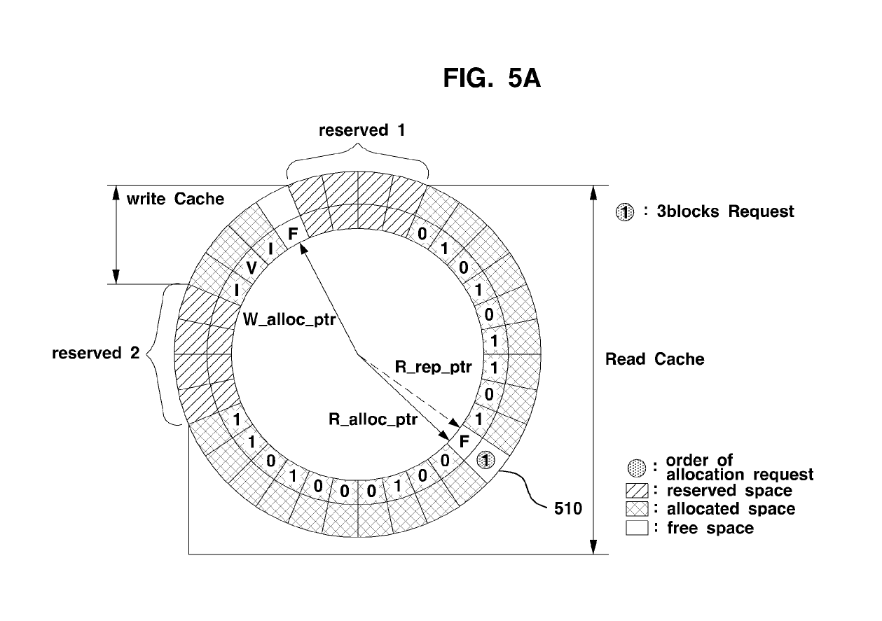

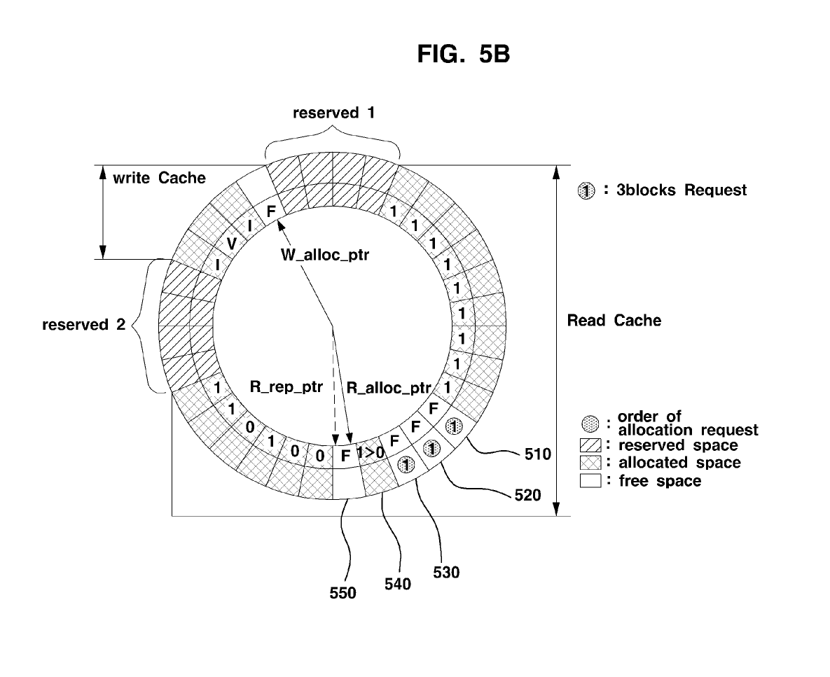

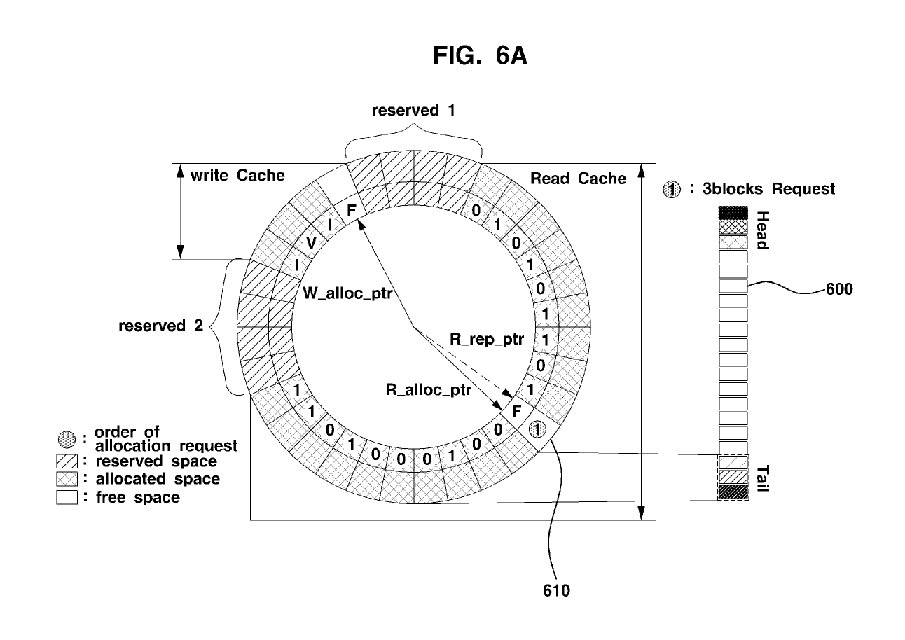

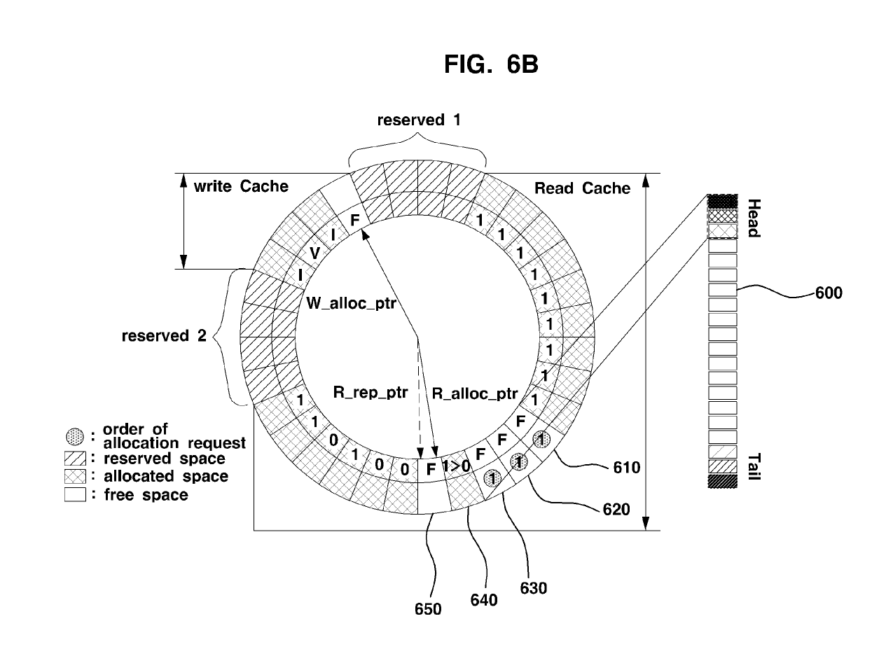

Hereinbelow is an explanation of an example of a data processing method of replacing data recorded in the aforementioned non-volatile memory cache 200 having a ring structure, with reference to FIGS. 5A to 6B.

FIGS. 5A and 5B illustrate a process of selecting blocks to be replaced in the first method. FIG. 5A is a view illustrating a case where an access has occurred regarding new data corresponding to three blocks in a state where one empty block is left in the reading cache region. In addition, FIG. 5B is a view illustrating a state where three blocks are selected as empty blocks, according to an exemplary embodiment of the present disclosure.

As illustrated in FIG. 5A, in a case where a reading access of \textcircled{1} (access to new data corresponding to three blocks) occurred in a state where one empty block 510 is left in the reading cache region, the storage device 100 checks the value of the spare region of the corresponding block while shifting the reading replacement pointer (R_rep_ptr) consecutively in a clockwise direction. In addition, in a case where the value of the spare region of the corresponding block is ‘1’, the storage device 100 changes it to ‘0’, and if the value of the spare region of the corresponding block is ‘0’, the storage region 100 deletes the block and makes it into an empty block.

Therefore, as illustrated in FIG. 5B, it can be seen that the storage device 100 made the second block 520, third block 530, and fifth block 550 into empty blocks, and for the fourth block 540, changed the value of the spare region from ‘1’ to ‘0’.

Next, after reading the data subject to access from the disk array 120, the storage device 100 records the data subject to access in the first block 510, second block 520, and third block 530. In addition, the storage device 100 corresponds the reading allocation pointer (R_alloc_ptr) and reading replacement pointer (R_rep_ptr) to the empty block, the fifth block 550.

Meanwhile, FIGS. 6A and 6B illustrate a process of selecting blocks to be replaced in the second method. FIG. 6A is a view illustrating a case where an access occurred regarding new data corresponding to three blocks in a state where one empty block is left in the reading cache region, according to an exemplary embodiment of the present disclosure. In addition, FIG. 6B is a view illustrating a state where three blocks are selected as empty blocks using the access list, according to an exemplary embodiment of the present disclosure.

As illustrated in FIG. 6A, in a case where a reading access of \textcircled{1} (access to new data corresponding to three blocks) has occurred in a state where one empty block 610 is left in the reading cache region, the storage device 100 checks the value of the spare region of the corresponding block while shifting the blocks of the items starting from those closest to the Tail of the access list 600 consecutively in a Head direction. In addition, the storage device 100 changes the value of the spare region of the corresponding block, from ‘1’ to ‘0’, and if the value is ‘0’, deletes the block and makes it into an empty block.

Therefore, as illustrated in FIG. 6B, it can be seen that the storage device 100 made the second block 520, third block 530, and fifth block 550 into empty blocks, and changed the value of the spare region from ‘1’ to ‘0’.

Next, after reading the data subject to access from the disk array 120, the storage device 100 records the data subject to access in the first block 510, second block 520, and third block 530. In addition, the storage device 100 shifts the items corresponding to the first block 510, second block 520, third block 530 in the Head direction in the access list. In addition, the storage device 100 corresponds the reading allocation pointer (R_alloc_ptr) and reading replacement pointer (R_rep_ptr) to the fifth block 550 which is an empty block.

Hereinabove was an explanation of an example of a data processing method of replacing data recorded in the non-volatile memory cache 200 having a ring structure.

Secondly, hereinbelow is an explanation of a data processing method which garbage collects data recorded in the non-volatile memory cache 200 having a ring structure.

In a case where all pages of the writing cache region 210 of the non-volatile memory cache 200 having a ring structure are used, the storage device 100 records all valid data recorded in the writing cache region 210 in the disk array 120, deletes the writing cache region 210, and then performs a garbage collection operation of shirting as many as a certain number of blocks.

First, when all pages of the writing cache region 210 are used, the storage device 100 records all valid pages in the invalid blocks of among the blocks of the writing cache region 210 in the block of the first reservation region 230. Herein, the invalid represents a block which displays that the spare region includes a page of which data is invalid (for instance, “I”), and the valid page represents a block which displays that the spare region includes a page of which data is valid (for instance, “V”).

More specifically, the storage device 100 places the writing replacement pointer (W_rep_ptr) in the first invalid block in the writing cache region 210. The storage device 100 searches for a valid page in the invalid block. Then, the storage device 100 records the valid page in the invalid block in the first reservation region 230. Next, the storage device 100 places the writing replacement pointer (w_rep_ptr) in the next invalid block, and then repeats the abovementioned process until the last invalid block of the writing cache region. Through this process, in a case where all pages of the writing cache region 210 are used, the storage device 100 records the valid pages in the invalid blocks of among the writing cache region 210 in the block of the first reservation region 230.

Next, the storage device 100 deletes all the invalid blocks in the writing cache region 210. Then, the storage device 100 copies all the data of the valid blocks in the writing cache region 210 and the data recorded in the block of the first reservation region 230 to the disk array 120. Furthermore, the storage device 100 deletes the valid blocks in the writing cache region 210 and at least one block where data of the first reservation region 230 is recorded.

Then, the storage device 100 shifts the writing cache region 210 by at least one block where the data of the first reservation region 230 is recorded. More specifically, assuming that there are L (L is a natural number of or above 1) number of blocks of at least one block where data of the first reservation region 230 is recorded, the storage device 100 copies the L number of blocks of the reading cache region 230 adjacent to the first reservation region 230 to the second reservation region 240, and deletes the L number of blocks of the reading cache region 230 and makes empty blocks. Herein, the L number of blocks of the reading cache region 230 adjacent to the first reservation region 230 are copied consecutively starting from the blocks adjacent to the reading cache region 230 of among the second reservation region 240. Next, the storage device 100 shifts the writing cache region 210 by the L number of blocks in the first reservation region 230 direction. Through such a process, the storage device 100 becomes able to shift the writing cache region 210 by at least one block where the data of the first reservation region 230 is recorded.

Through such a process, when all pages of the writing cache region 210 of the non-volatile memory cache 200 having a ring structure are used, the storage device 100 records all the valid data recorded in the writing cache region 210 in the disk array 120, deletes all the writing cache region 210, and the becomes able to perform a garbage collection operation of shifting it by a certain number of blocks.

Of among non-volatile memories, a flash memory has a limited number of block deleting opportunities to about a several million times, and thus deleting calculations may be concentrated on a certain block, thereby wearing out or making it unusable, but when the writing cache region 210 is shifted regularly, the possibility of wearing-out may be minimized.

Hereinbelow is an explanation of an example of a data processing method of garbage collecting data recorded in the non-volatile memory cache 200 having the aforementioned ring structure.

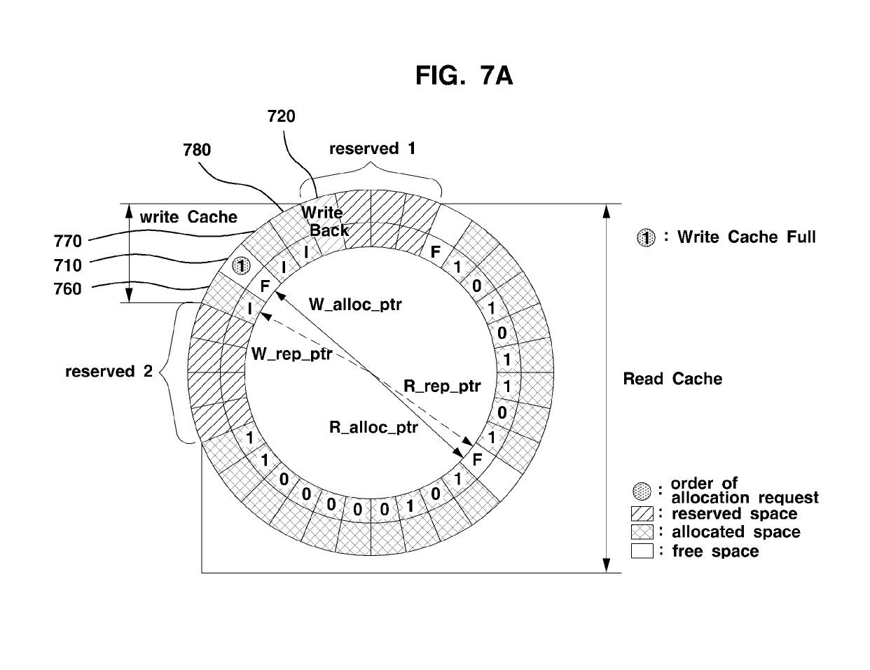

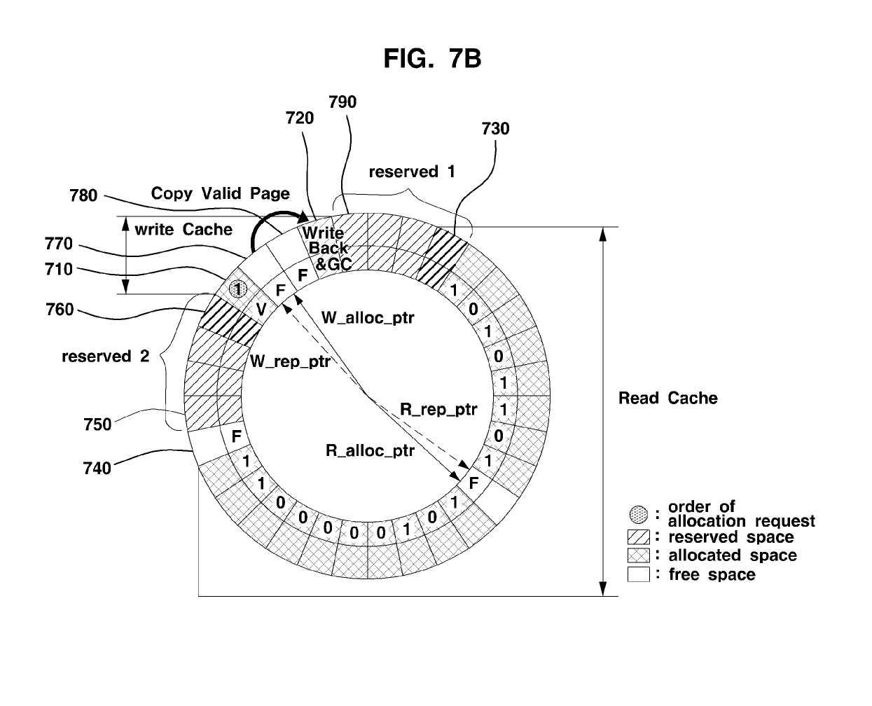

FIG. 7A is a view illustrating a case where all the writing cache regions are used, according to an exemplary embodiment of the present disclosure. In addition, FIG. 7A is a view illustrating a state where the writing cache region has been shifted by one block in a clockwise direction in a garbage collection process.

As illustrated in FIG. 7A, in a case where data is recorded in the first block 710 and all the writing cache regions are used, the storage device 100 starts the garbage collection. Herein, as illustrated in FIG. 7A, the second block 720 of the first reservation region 230 is in a state where data is recorded in a portion of the pages through an out-place update.

In this state, as illustrated in FIG. 7B, the storage device 100 records valid pages included in all invalid blocks 760, 770, 780 in the writing cache region 210 in the block inside the first reservation region 230, and then deletes all the invalid blocks 760, 770, 780. FIG. 7B illustrates a state where valid pages included in the all invalid blocks are recorded in the second block 720. Next, the storage device 100 copies the data recorded in the first block 710 and second block 720 to the disk array 120, and deletes the first block 710 and second block 720.

Next, in order to incorporate the second block 720 into the writing cache region 210, the storage device 100 shifts the writing cache region 210 by one block in a clockwise direction. To this end, the storage device 100 shifts the third block 730 to the fourth block 740 of the second reservation region 240, and then incorporates the third block 730 into the first reservation region 230. In addition, the storage device 100 incorporates the sixth block 760 into the second reservation region 240, thereby shifting the second reservation region 240 by one block so that it comes between the fifth block 750 and sixth block 760.

Through this process, the storage devices finishes the garbage collection operation, and the writing cache region 210 is shifted by one block in a clockwise direction.

The explanation so far was about the data processing method which performs a garbage collection on the data recorded in the non-volatile memory cache 200 having the aforementioned ring structure.

Meanwhile, it is a matter of course that the technical concept of the present disclosure may be applied to a computer which stores a computer program which embodies a non-volatile memory cache having a ring structure and the aforementioned data processing method according to an exemplary embodiment of the present disclosure. In addition, the technical concept according to various exemplary embodiments of the present disclosure may also be embodied as a computer readable code format recorded in a computer readable record medium. Any data storage device which may store data and may be read by a computer may be used. For example, a computer readable record medium may be any one of a ROM, RAM, CD-ROM, magnetic tape, floppy disk, optical disk, and hard disk drive etc. In addition, a computer readable code or program stored in a computer readable record medium may be transmitted through a network connected among computers.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A storage device comprising:
a non-volatile memory cache which is embodied as a non-volatile memory and performs a cache function of storing data temporarily; and
a CPU which accesses data from the non-volatile memory cache, wherein the non-volatile memory cache has a storage region configured in a ring structure.

2. The storage device according to claim 1, wherein the non-volatile memory cache is divided into a reading cache region and writing cache region.

3. The storage device according to claim 2, wherein the reading cache region has more storage regions allocated than the writing cache region.

4. The storage device according to claim 1, wherein the non-volatile memory cache comprises:
a writing cache region used for writing access operations;
a reading cache region used for reading access operations; and
a first reservation region and second reservation region which are regions reserved for an outplace update and garbage collection.

5. The storage device according to claim 4, wherein the first reservation region is allocated to have a size same as or within twice the size of the writing cache region, and
the second reservation region is allocated to have a size same as or within twice the size of the writing cache region.

6. The storage device according to claim 1, wherein the non-volatile memory cache is one of an SSD (Solid State Drive) and flash memory.

7. A data processing method comprising:
when a reading access is requested, executing a reading access in block units in a reading cache region of a non-volatile memory cache having a storage region configured in a ring structure; and
when a writing access is requested, executing a writing access in page units in a writing cache region of the non-volatile memory cache.

8. The data processing method according to claim 7, wherein the executing a reading access comprises:
when a reading access is requested, searching in block units whether or not first data which corresponds to the requested reading access exists in a reading cache region of a non-volatile memory cache;
when first data exists in a reading cache region, reading corresponding data from a first block which is a block corresponding to the first data;
displaying that there has been an access to a spare region of the first block; and
corresponding a reading allocation pointer to an empty block located next to the first block.

9. The data processing method according to claim 7, wherein the executing a reading access comprises:
when a reading access is requested, searching in block units whether or not first data which corresponds to the requested reading access exists in a reading cache region of a non-volatile memory cache;
when the first data does not exist in a reading cache region, reading first data from a disk array;
recording first data in a second block which is an empty block where a reading allocation pointer corresponds to;
displaying that data has been recorded in a spare area of the second block but there has been no access; and
corresponding a reading allocation pointer to an empty block located next to the second block.

10. The data processing method according to claim 7, wherein the executing a writing access comprises, when a writing access is requested, searching in page units whether or not second data which corresponds to the requested writing access exists in a writing cache region of the non-volatile memory cache.

11. The data processing method according to claim 10, wherein the executing a writing access further comprises:
when the second data exists in a writing cache region, displaying that data recorded in a spare area of page 1 which is a page corresponding to second data has been invalidated;
displaying that there is an invalidated page in a spare region of a third block which is a block including the page 1; and
recording second data in a first reservation region of the non-volatile memory cache; and
corresponding a writing allocation pointer to an empty page located next to the first page.

12. The data processing method according to claim 10, wherein the executing a writing access further comprises:
when the second data does not exist in a writing cache region, recording the second data in page 2 which is an empty page where a writing allocation pointer corresponds to;
displaying that data recorded in a spare region of the page 2 is valid;
when there is an empty page in a block which includes the page 2, shifting the writing allocation pointer (W_alloc_ptr) to a next empty page; and
when there isn't an empty page in a block which includes the page 2, shifting the writing allocation pointer to a next block.
